(19) United States
(12) Patent Application Publication
(10) Pub. No.: US 2003/0134100 A1
(43) Pub. Date: Jul. 17, 2003

(54) Discrete hydrophilic-hydrophobic porous materials and methods for making the same

(76) Inventors: Guoqiang Mao, Smyrna, GA (US); George W. Greene IV, Peachtree City, GA (US); Richard J. Coppola, Peachtree City, GA (US); Li Yao, Peachtree City, GA (US)

Correspondence Address: PENNIE & EDMONDS LLP, 1667 K STREET NW, SUITE 1000, WASHINGTON, DC, 20006

(21) Appl. No.: 10/300,734

(22) Filed: Nov. 21, 2002

Related U.S. Application Data
(60) Provisional application No. 60/331,723, filed on Nov. 21, 2001.

(51) Int. Cl. B32B 3/26

(52) U.S. Cl. 428/304.4

(57) ABSTRACT

This invention relates to porous polymeric materials having discrete regions that exhibit distinct surface properties. The invention also relates to methods of making such porous polymeric materials and their applications. The geography of the discrete regions can be determined in a selective and controlled manner. Porous materials having discrete regions of distinct hydrophilicity, hydrophobicity, oleophobicity, biological molecules binding capability, wetting and wicking property, presence or density of functional groups, chemical reactivity, electric charges, porosity and pore sizes can be manufactured using this invention.

### 1. FIELD OF THE INVENTION

This invention relates to porous polymeric materials having a plurality of discrete surface regions of different properties, and methods for making the same.

### 2. BACKGROUND OF THE INVENTION

Porous materials, including metal, ceramic, glass and polymeric materials, have increasingly been used in a variety of applications, such as filtration, aeration, wicking, implant and other biomedical devices. For example, porous polymeric materials can be used in medical devices that serve as substitute blood vessels, synthetic and intra-ocular lenses, electrodes, catheters, and extra-corporeal devices such as those that are connected to the body to assist in surgery or dialysis. Porous polymeric materials can also be used as filters for the separation of blood into component blood cells and plasma, microfilters for removal of microorganisms from blood, and coatings for ophthalmic lenses to prevent endothelial damage upon implantation. Porous materials have also been used in diagnostic devices such as lateral flow devices, flow through devices and other immunoassay devices.

The hydrophobic nature of many polymers, however, has limited the usefulness of porous materials made from them. Therefore, attempts have been made to modify the surface properties of the porous materials. Various methods were contemplated to achieve such modifications on the surface properties. Examples of such methods include: addition of organic surfactants; plasma discharge as disclosed in, for example, U.S. Pat. Nos. 4,845,132 and 6,022,902; electron beam discharge as disclosed in, for example, U.S. Pat. No. 6,271,273; corona discharge as disclosed in, for example, U.S. Pat. No. 5,688,465; and treatment by solutions as disclosed in, for example, U.S. Pat. Nos. 5,540,837, 5,695,640, 5,700,559, 5,807,636, 5,837,377, 5,914,182, 5,916,585, and 6,060,410. The contents of the recited U.S. patents are incorporated herein by reference.

Among the different techniques available for modifying the surface property of polymeric materials, most are limited in their ability to control the degree to which a surface is modified, and many are expensive, inefficient, or unable to be used to modify porous surfaces without clogging their pores. Moreover, although different modifications can be introduced onto porous materials using these techniques, these techniques are directed to methods of modifying the surface properties of the whole piece of porous material.

On the other hand, porous materials with selectively predetermined discrete areas of various surface properties have a wide variety of applications in single piece diagnostic devices, multi-channel biological assays, microfluidic devices, combinatory chemistries, and fast biological molecule and drug screening. Therefore, there exists a need to develop a porous material with selectively predetermined discrete regions of various surface properties.

### 3. SUMMARY OF THE INVENTION

This invention encompasses novel porous materials containing discrete regions of different surface properties and methods of their manufacture. Materials of the invention comprise a porous substrate to which chemical or biological moieties are selectively bound in discrete patterns, or in which discrete regions on the surface of the substrate are selectively activated.

A first embodiment of this invention is directed to a single piece porous polymeric material having a surface that contains a plurality of discrete regions that exhibit distinct surface properties.

Specific examples of polymers from which materials of the present invention can be made include, but are not limited to, polyolefin, polyether, polyurethane, polycarbonate, polyetheretherketone, poly(phenylene oxide), poly(ether sulfone), polysulfone, nitrocellulose, cellulose, fluorinated polymers, PTFE, porous fiber materials or nylon. Polyolefins include, but are not limited to, ethylene vinyl acetate, ethylene methyl acrylate, polyethylene, polypropylene, ethylene-propylene rubber, ethylene-propylene-diene rubbers, poly(1-butene), polystyrene, poly(2-butene), poly(1-pentene), poly(2-pentene), poly(3-methyl-1-pentene), poly(4-methyl-1-pentene), 1,2-poly-1,3-butadiene, 1,4-poly-1,3-butadiene; polyisoprene, polychloroprene, poly(vinyl acetate), poly(vinylidene chloride), poly(vinylidene fluoride), poly(tetra fluoro ethylene), or mixtures thereof.

Surface properties that can be introduced onto the porous materials of this invention include, but are not limited to, hydrophilicity, hydrophobicity, oleophobicity, biological molecules binding capability, wetting or wicking property, presence or density of functional groups, chemical reactivity, electric charges, porosity, and pore sizes.

Discrete regions can consist of hydrophilic and hydrophobic regions. In this respect, the present invention encompasses a porous material wherein discrete hydrophilic regions are surrounded by hydrophobic boundaries. Alternatively, discrete hydrophobic regions may be surrounded by hydrophilic boundaries. In another aspect, discrete regions can also be hydrophobic and oleophobic.

In a given piece of porous material of this invention, all of the discrete regions may exhibit the same surface property. On the other hand, different discrete regions may have different surface properties in a given piece of the porous material.

The porous materials of this invention can include the ones wherein the discrete regions are coated with coating materials that alter the surface properties of the discrete regions. The coating can be single layered, double layered, or optionally multiple layered. The coating layers are bound to the layer right underneath them by covalent bonds, electrostatic interactions, or combination thereof.

Suitable coating materials include, but are not limited to, polyelectrolyte, neutral polymer, small molecule, biomolecule, or combination thereof.

Specific polyelectrolytes include, but are not limited to, a phosphate, polyethyleneimide, poly(vinylimidazoline), quaterized polyacrylamide, carboxyl modified polyacrylamide, polyvinylpyridine, poly(vinylpyrrolidone), polyvinylamine, polyallylamine, chitosan, polylysine, poly(acrylate trialkyl ammonia salt ester), cellulose, poly(acrylic acid), polymethylacrylic acid, poly(maleic acid), poly(styrenesulfuric acid), poly(vinylsulfonic acid), poly(toluene sulfuric acid), poly(methyl vinyl ether-alt-maleic acid), poly(glutamic acid), Nafion® (DuPont), surfactant, dextran sulfate, hyaluric acid, heparin, alginic acid, adipic acid, chemical dye, protein, enzyme, nucleic acid, peptide, or a salt, ester, and/or copolymer thereof.

Specific neutral polymers include, but are not limited to, isocyannated terminated polymer, epoxy-terminated polymer, or hydroxylsuccimide terminated polymer. More specific examples of neutral polymer include polyurethane, poly(ethylene glycol), and polysiloxane.

Specific small molecules include, but are not limited to, sodium dodecylsulfonate, dodecyltrimethylamonium bromide, phosphate, sulfonate, bronate, sulfonate, dye, lipid, metal ion, or surfactant containing fluorine.

Specific biomolecules include, but are not limited to, proteins, enzymes, lipids, hormones, peptides, nucleic acids, oligonucleic acids, DNA, RNA, sugars, or polysaccharides.

The porous material of this invention may have electric charges in the discrete regions. The charge may be the same in all discrete regions, or different charges can be present in different discrete regions. In addition, regardless of whether all of the discrete regions have the same charge or not, different charge densities may be present in different discrete regions.

Moreover, the porous material of this invention may have chemical functional groups in the discrete regions. All of the discrete regions may contain the same chemical functional group, or different discrete regions may contain different chemical functional groups. Again, regardless of the type of functional groups, different discrete regions can contain different densities of chemical functional groups. Specific examples of chemical functional groups include, but are not limited to, an amino group, carboxylic acid, sulfuric acid, a polysaccharide, or a perfluroalkyl group.

In another aspect of this invention, the discrete regions on the material of this invention can be three dimensionally located. In other words, the porous discrete parts in the invention can also be in z-direction, in addition to x- and/or y-direction. For example, on a single piece of discrete porous material of this invention, upper part of the material may have a different chemical property from the bottom part.

In another embodiment, this invention is directed to a method of making porous materials having a plurality of discrete regions that exhibit distinct surface properties. The method comprises arranging polymer particles that have different properties in a predetermined pattern and compress sintering the particles to provide a porous material. In certain cases, the resulting porous material can take the form of a billet. In such cases, the porous material can optionally be skived into sheets.

In another embodiment, the porous materials of this invention are made by a method comprising selectively placing polymer powders in a predetermined pattern on discrete regions of a porous substrate and compress sintering the polymer powders into the substrate.

In one aspect, the same polymer powders are used in all discrete regions on the substrate to provide all discrete regions with the same chemical properties. As a variation, polymer powders made from different polymers can be used to provide discrete regions of different chemical surface properties in a given porous material.

In a specific embodiment, polymer powders that are hydrophilic are placed onto discrete regions of hydrophobic porous substrate. The resulting porous material has discrete hydrophilic-hydrophobic regions.

In one aspect, certain specific embodiments of this invention are directed to a method of making a porous material that exhibits the same porosity or pore size in all discrete regions. Alternatively, different porosity or pore sizes may be introduced onto different discrete regions.

Another embodiment of this invention is directed to another method of making the porous materials of this invention. This method comprises providing a porous substrate and selectively activating discrete regions of the substrate in a predetermined manner. To activate the surface of the porous substrate, high-energy activation is used. Examples of high-energy activation include, but are not limited to, direct and remote plasma activation, corona discharge, electron beam, and UV radiation. Surface regions that are exposed to the high energy activation acquire hydrophilic properties, whereas other regions of the surface remain hydrophobic.

Several different methods are employed to yield selective activation of discrete regions. For activation methods such as plasma activation, corona discharge, or UV radiation, one or more masks with desired pattern, which can shield certain portions of the substrate while leaving other portions exposed, can be employed to achieve selective activation. Suitable materials from which the mask can be made include, but are not limited to, metals, plastics, rubbers, and paper tapes.

In case that the corona discharge activation is used, a specially designed electrode can be used to achieve a selective activation in addition to the use of masks. Selective activation is achieved because the electrode is designed to have the exact shape of the discrete regions to be activated, thus the regions exposed to the electrode will become hydrophilic, while the unexposed regions will remain hydrophobic.

For activation methods such as electron beam activation, the electron beam can simply be focused to specified discrete regions to achieve the selective activation.

The porous materials of this invention may contain discrete regions that have been subjected to coating procedures. Accordingly, another embodiment of this invention is directed to a method comprising coating the discrete surface regions with coating materials for a time and at a temperature sufficient for a formation of a layer covering the discrete regions. The coating materials can include polyelectrolyte, neutral polymer, small molecule, biomolecule, or combination thereof. The layer formed from this treatment is preferably bound to the activated discrete regions by covalent bonds, electrostatic interactions, or combination thereof.

In one specific embodiment, this invention is directed to a method of further coating the porous materials to provide a double-layer coated porous materials. The second layer is bound to the first layer by covalent bonds, electrostatic interactions, or combination thereof There is no limit as to the number of coating cycles and thus the number of coating layers that can be introduced on the discrete regions.

In certain embodiments, charged molecules containing the desired functional groups can be reacted with oppositely charged discrete regions to introduce functional groups. Examples of such charged molecules include, but are not limited to, charged polyethylene glycol (PEG), charged biotin, charged DNA, charged RNA, or charged proteins.

### 4. BRIEF DESCRIPTION OF FIGURES

To better understand specific novel aspects of this invention, reference can be made to the figures described below:

FIG. 1 provides an illustration of direct sintering of polymer powders to form discrete regions of distinct properties;

FIG. 2 illustrates skiving of a porous material following direct sintering to form a sheet of porous material having discrete surface regions;

FIG. 3 provides an illustration of sintering a porous material on top of another material to form discrete surface regions;

FIG. 4 provides an illustration of selective plasma and corona discharge activation of porous materials using a mask;

FIG. 5 illustrates selective corona discharge activation of porous materials without a mask;

FIG. 6 illustrates a general schematic of a multi-layer coating process of porous materials;

FIG. 7 provides an illustration of a porous material containing functional groups in discrete regions;

FIG. 8 provides an illustration of a porous material containing different electric charges in discrete regions;

FIG. 9 provides an illustration of three-dimensional discrete porous materials;

FIG. 10 illustrates an application of the porous material of this invention in a lateral flow device;

FIG. 11 illustrates an application of the porous material of this invention in a 96-well plate;

FIG. 12 illustrates an application of the porous material of this invention in a liquid/chemical delivery and microfluidic device; and

FIG. 13 illustrates an application of the porous material of this invention in a multi-channel lateral flow diagnostic device.

### 5. DETAILED DESCRIPTION OF THE INVENTION

This invention is directed, in part, to a single piece of porous polymeric material comprising a plurality of discrete surface regions that exhibit distinct surface properties. As used herein, the term “single piece” means that components of the piece are physically connected without third component materials such as glue, adhesive, or tape, etc. The shape of this single piece is not limited to a specific form. Examples of feasible shapes include, but are not limited to, sheets, rods, films, blocks, fibers, tubes, and molded parts.

The distinct properties that can be introduced onto the surface of the porous materials of this invention include, but are not limited to, hydrophilicity, hydrophobicity, oleophobicity, biological molecules binding capability, wetting or wicking property, presence or density of functional groups, chemical reactivity, electric charges, porosity, and pore sizes. A specific embodiment of this invention is directed to a porous material that has discrete hydrophilic and hydrophobic regions. The hydrophilic and hydrophobic discrete porous regions are distinguished by the wetting of aqueous solution at atmospheric pressure. The aqueous solution will wet or wick the hydrophilic areas, but not the hydrophobic areas.

Another specific embodiment is directed to a porous material that has discrete hydrophobic and oleophobic regions. Oleophobicity can be defined by the wetting of organic solvents, such as ethanol, acetone, gasoline, etc., at atmospheric pressure. The organic solvents will not wet or wick the oleophobic areas, whereas such solvents will wet or wick the hydrophobic areas. More specific embodiment is directed to a porous material that has discrete hydrophilic regions surrounded by hydrophobic boundaries.

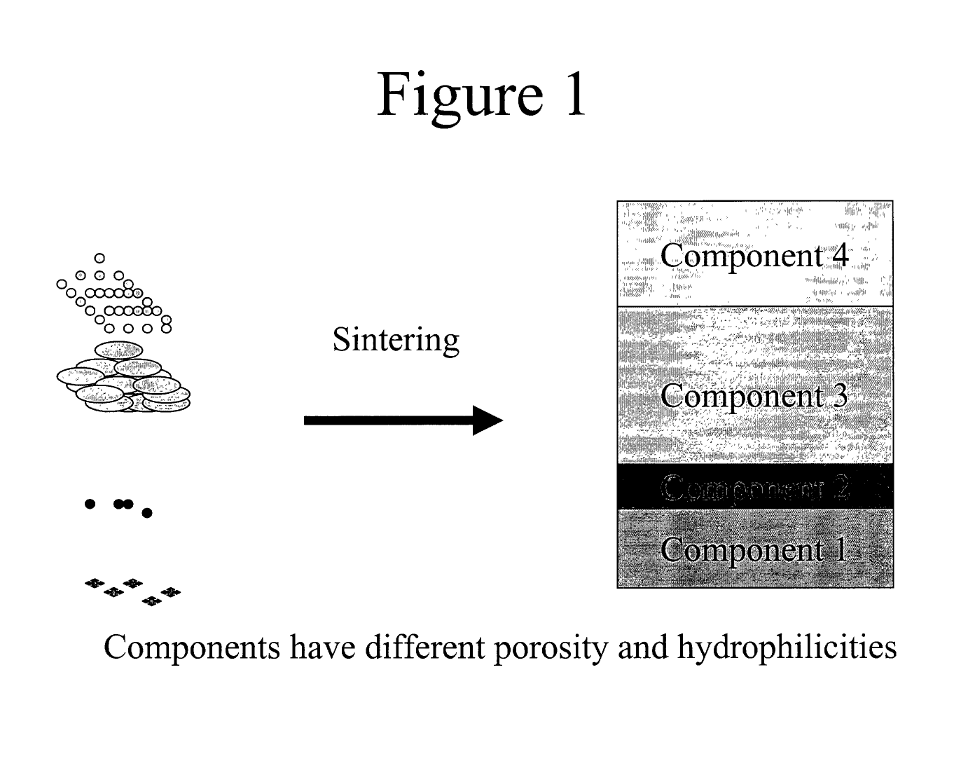

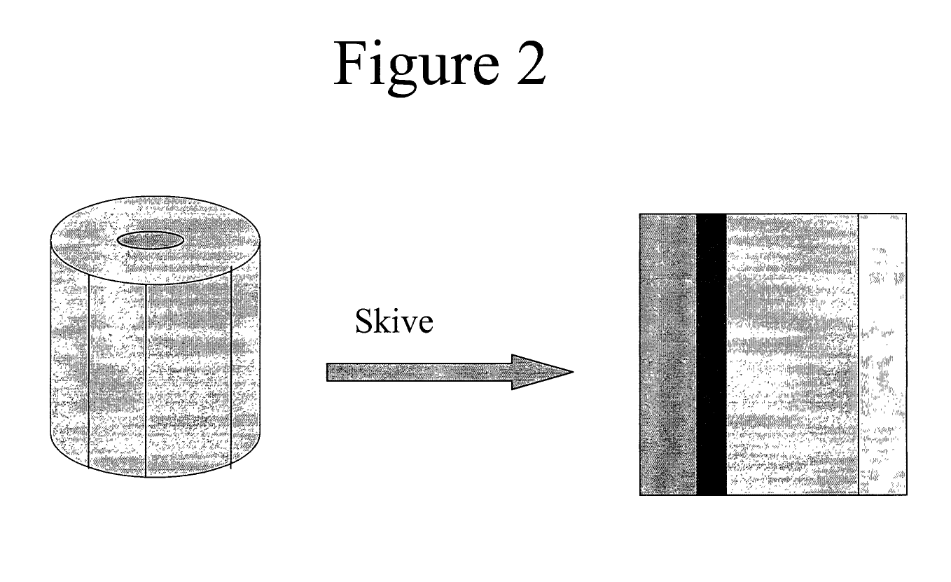

This invention is also directed, in part, to methods of making the porous polymeric material. In one embodiment, the porous materials of the present invention is made by using a method comprising arranging polymer particles that have different properties in a predetermined pattern and compress sintering the particles to provide a porous material (FIG. 1). If the resulting porous materials take the form of a billet, they can be optionally skived into sheets (FIG. 2).

The porous materials of this invention can also be made by a method comprising providing a porous substrate, selectively placing polymer powders in a predetermined pattern on discrete regions of the substrate, and compress sintering the polymer powders into the substrate. Depending on the types of polymer powders used, same property can be introduced in all discrete regions, or different properties may be introduced in different discrete regions.

In another embodiment, the porous materials of this invention can be made using a method that comprises providing a porous substrate, and selectively activating discrete regions of the substrate. A high-energy activation method is employed for this activation.

Various coating techniques may be employed to provide the porous materials of the present invention. In general, the porous materials are treated with coating materials for a time and at a temperature sufficient for a formation of a layer covering the discrete regions. This treatment can be repeated as desired to achieve a multi-layer coating on the discrete regions of the porous material. Detailed discussion of various aspects of this invention is provided below.

5.1 Materials

Materials of this invention can be made using methods described herein from materials such as, but not limited to, those discussed below.

5.1.1 Substrates

Substrates that can be used to provide materials of the invention can be solid or porous, and can come in any of a variety of shapes and forms. For example, substrates can be blocks, rods, films, molded parts, tubes, fibers, and sheets.

The solid and porous substrates can be made of a variety of materials, such as, but not limited to: metals (e.g., Cu, Ag, Au, Al, Zn, and Fe); alloys; glasses; ceramics; carbon black; silica; silicon; and polymeric materials or plastics. As used herein, “porous materials” or “porous substrate” refers to a material or a substrate that has a surface with one or more pores or a surface that is uneven, undulating, or not smooth or flat, such as a woven, non-woven, compressed, perforated, or etched material or substrate.

A specific substrate of the present invention is a porous polymeric or plastic material. Porous polymeric materials can usually be made from a variety of thermoplastic and thermoset materials using methods known in the art such as, but not limited to, sintering and casting. Thus, for example, suitable polymers for the substrate are those that can be sintered to form sheet or membrane-like porous materials. Examples of suitable thermoplastic or thermoset materials include, but are not limited to, polyolefin, polyurethane, polycarbonate, polyether ether ketone (PEEK), poly(phenylene oxide), poly(ether sulfone), polysulfone, nitrocellulose, cellulose, fluorinated polymers, PTFE, porous fiber materials or nylon.

One of the specific substrates are polyolefins. Examples of polyolefins suitable for the present invention include, but are not limited to: ethylene vinyl acetate (EVA); ethylene methyl acrylate (EMA); polyethylenes such as, but not limited to, low density polyethylene (LDPE), linear low density polyethylene (LLDPE), high density polyethylene (HDPE), and ultra-high molecular weight polyethylene (UHMWPE); polypropylenes; ethylene-propylene rubbers; ethylene-propylene-diene rubbers; polystyrene; poly(1-butene); poly(2-butene); poly(1-pentene); poly(2-pentene); poly(3-methyl-1-pentene); poly(4-methyl-1-pentene); 1,2-poly-1,3-butadiene; 1,4-poly-1,3-butadiene; polyisoprene; polychloroprene; poly(vinyl acetate); poly(vinylidene chloride); poly(vinylidene fluoride); poly(tetra fluoro ethylene); and mixtures and derivatives thereof.

Specific polyethylene materials include, but are not limited to, those in the Exact® series manufactured by Exxon Chemical Company, such as Exact SLX-9090, Exact 3024, Exact, 3030, Exact 3033, Exact 4011, Exact 4041, Exact SLP-9053, Exact SLP-9072, and Exact SLP-9095. Specific examples of LDPE include, but are not limited to, those in the 20 series manufactured by DuPont Chemical Company, Wilmington, Del., such as 20 series 20, 20 series 20-6064, 20 series 2005, 20 series 2010, and 20 series 2020T. Specific examples of LLDPE include, but are not limited to, those in the Exact® series manufactured by Exxon Chemical Company, such as Exact 3022 and Exact 4006. Specific examples of HDPE include, but are not limited to, those in the Escorene HX® series manufactured by Exxon Chemical Company, such as Escorene HX-0358.

Ultra-high molecular weight polyethylenes include, but are not limited to, UHMWPE having a molecular weight greater than about 1,000,000. Typically, UHMWPE displays no measurable flow rate under normal test procedures. See, U.S. Pat. No. 3,954,927, herein incorporated by reference. Ultra-high molecular weight polyethylene also tends to have enhanced mechanical properties compared to other polyethylenes, including, but not limited to, abrasion resistance, impact resistance and toughness. Polyethylenes having weight average molecular weights of 1,000,000 or higher, which are included within the class designated as UHMWPE, typically an intrinsic viscosity in the range of about 8 or more. Specific examples of UHMWPE include, but are not limited to, Hostalen GUR® sold by Ticona Inc., League City, Tex.

Polypropylenes include, but are not limited to: the Polyfort® series manufactured by A Shulman Co., Akron, Ohio, such as FPP 2320E, 2321E, 2322E, 2345E, PP2130, and PP2258; the Acctuf® series manufactured by BP Amoco Corporation, Atlanta, Ga., such as Acctuf 3045, Amoco 6014, and Amoco 6015; the Aristech® series manufactured by Aristech Chemical Corp., Pittsburgh, Pa., such as D-007-2, LP-230-S, and TI-4007-A; the Borealis® series manufactured by BASF Thermoplastic Materials, Saint Paul, Minn., such as BA101E, BA110E, BA122B, BA204E, BA202E, and BA124B; the Polypro® series manufactured by Chisso America Inc., Schaumburg, Ill., such as F1177 and F3020; the Noblen® series manufactured by Mitsubishi Petrochemical Co. Ltd., Tokyo, Japan, such as MA8; the Astryn® series manufactured by Montell USA Inc., Wilmington, Del., such as 68F4-4 and PD451; the Moplen® series manufactured by Montell USA Inc., such as D 50S, D 60P, and D 78PJ; and the Pro-Fax® series manufactured by Montell USA Inc., such as 6723, 6823, and 6824.

As a practical matter, the term “pore” is an artificial one that can have various meanings. According to the present invention, the average sizes, shapes, and number of pores in a material can be determined by taking a cross-section of the material. For the purpose of this invention, holes and depressions in the cross-section are considered pores. And, while only two-dimensional sizes and shapes of those pores can be determined from the cross-section, information about their third dimension (e.g., their depth) can be determined from a second cross-section, orthogonal to the first. Also, average pore size, pore volume, and/or surface area can be inferred from measurements obtained using a mercury intrusion porisometer. For the purpose of this invention, pore sizes are typically referred to in terms of their average diameters, even though the pores themselves are not necessarily spherical.

The particular method used to form the pores or channels of a porous polymeric material and the resulting porosity (i.e., average pore size and pore density) of the porous material can vary according to the desired application for which the final membrane be used. The desired porosity of the matrix can also be affected by the polymeric material itself, as porosity can affect in different ways the physical properties (e.g., tensile strength and durability) of different materials. For the purpose of this invention, pore size and pore density can be determined using, for example, a mercury porisometer and scanning electron microscopy. Specific porous substrates of this invention have an average pore size of from about 0.001 μm to about 1000 μm, more specifically from about 0.01 μm to about 500 μm, from about 0.1 μm to about 200 μm, more specifically from about 1 μm to about 100 μm, more specifically from about 1 μm to about 50 μm, from about 1 μm to about 20 μm, even more specifically from about 1 μm to about 10 μm.

Although the porous polymeric material of the present invention can be made from the materials discussed above, many other materials that are commercially available can also be used for the purposes. Suitable substrates can be purchased from Porex Technologies, Fairbum, Ga.

5.1.2 Coating Materials

In one embodiment of this invention, the discrete regions of the porous materials are further coated using treatments by coating materials. Coating of discrete porous materials can be single layered or multilayered, preferably multilayered. The multilayer coating of the invention comprises at least two layers, the first of which is adhered (e.g., covalently or electrostatically) to the surface of discrete hydrophilic regions, and the second of which is adhered (e.g., electrostatically or covalently) to the first layer. Using the methods disclosed herein as well as the ones known in the art, additional layers can be adhered atop the second layer and to one another. Suitable coating materials include, but are not limited to, polyelectrolytes, neutral polymers, small molecules, biomolecules, or combinations thereof.

Certain materials forming coating layer contain net cationic or anion charges, or localized cationic or anionic charges (e.g., zwitterions). Alternatively, they can provide net or localized charges when adhered or deposited onto the discrete porous materials. Other materials forming coating layer may contain functional groups that can form covalent bonds with the discrete porous materials under certain conditions (e.g., dry, heat, coupling reagents).

As used herein, unless otherwise indicated, the term “polyelectrolyte” means a polymer having electric charges. The polyelectrolyte may exist in a complex form, which is also called symplexes. Polyelectrolytes are divided into polyacids, polybases, and polyampholytes. Depending on the charge density in the chain, polyelectrolytes are divided into weak and strong. The charge of weak polyelectrolytes is determined by dissociation constants of ionic groups and pH of the solution. Strong polyelectrolytes in water solutions are mostly ionized independent of the solution's pH. Typical weak polyacid polyelectrolytes include, but are not limited to, poly(acrylic acid) and poly(methacrylic acid). Strong polyacid polyelectrolytes include, but are not limited to, poly(ethylenesulfonic acid), poly(styrenesulfoinic acid), and poly(phosphoric acid). Weak polybase polyelectrolytes include, but are not limited to, poly(4-vinylpyridine), polyethyleneimine (PEI), and polyvinylamine. Strong polybase polyelectrolytes can be obtained by alkylation of nitrogen, sulfur, or phosphorus atoms of weak polybase polyelcctrolytes. See “Concise Polymeric Materials Encyclopedia” (Joseph C. Salamone, 1999 by CRC Press LLC, ISBN 0-84932-226-X, pages 1140-1141). Other examples of polyelectrolytes include, but are not limited to, alginic acid, adipic acid, chemical dyes, proteins, enzymes, nucleic acids, peptides, or salts, esters, and/or copolymers thereof.

Organic materials that can be used to form coating layer on discrete hydrophilic areas of the invention include, but are not limited to, organic polymers, monomers, and biomolecules. Organic materials may contain net and/or localized cationic or anionic charges. Organic materials that are preferred for direct adhesion to the discrete porous materials are polymers such as, but not limited to, single and copolymers (e.g., random, graft, and block copolymers).

Examples of polymers or copolymers that contain cationic charges include, but are not limited to, polyethyleneimide (PEI), poly(vinylimidazoline), quaterized polyacrylamide, polyvinylpyridine, poly(n-vinylpyrrolidone), polyvinylamines, polyallylamines, chitosan, polylysine, poly(acrylate trialkyl ammonia salt ester), cellulose or other polymers that contains quaternizied groups of nitrogen, phosphor and polymer surfactants, or salts, esters, and/or copolymers thereof.

Examples of polymers or copolymers that contain anionic charges include, but are not limited to, polyacrylic acid (PAA), polymethylacralic acid, poly(styrenesulfuric acid) (PSSA), and their sodium salts, cellulose that contain sulfonated or carboxylic acid groups, carboxyl modified polyacrylamide, poly(vinylsulfonic acid), poly(toluene sulfuric acid), poly(methyl vinyl ether-alt-maleic acid) and ester, poly(glutamic acid), poly(maleic acid), Nafion® (DuPont), dextran sulfate, hyaluric acid, heparin, sodium carboxymethyl cellulose (CMC), anionic charged polymer surfactants, molecules containing phosphate groups, or salts, esters, and/or copolymers thereof.

Coating of hydrophilic areas on this invention can also be made from biomolecules. Certain biomolecules contain net or localized charges. Examples of biomolecules include, but are not limited to, biotin, proteins, enzymes, lipids, hormones, peptides, nucleic acids, oligonucleic acids, DNA, RNA, sugar and polysaccharides.

Polymers and copolymers that contain both cationic and anionic moieties can also be used to provide coating on the hydrophilic areas of this invention. For example, about one to about 99 percent of repeat units of a polymer can contain cationic moieties, preferably from about 20 to 80 percent. Amphoteric polymers (i.e., polymers wherein about 50 percent of the repeat units contain cationic groups and about 50 percent contain anionic groups) can also be used. Polymers and copolymers may have varying charge density (i.e., ratio of number of charge to the number of repeat units). For example, polymers with charge densities of from one to 100 percent, preferably from about 20 to about 100 percent, can be used.

Neutral polymers can also be used to form the multi-layers coating on hydrophilic areas of the invention, particularly polymers capable of forming covalent bonds with the components of other layers or with substrate surface under conditions such as those discussed herein. Examples of such neutral polymers include, but are not limited to: isocyannated terminated polymers, including polyurethane and PEG; epoxy-terminated polymers, including PEG and polysiloxanes; and hydroxylsuccimide terminated polymers.

The polymers and copolymers of the invention can be linear, comber, star or cyclic polymers. The copolymers can be random, graft, or block copolymers.

Molecules other than traditional polymers (e.g., small organic and inorganic molecules) can also be used to provide layers and coatings on the hydrophilic areas of the invention. These molecules can be used in any layer in the multi-layer coating, preferably, in the secondary or sequential layers, and more preferably be used combined with the polymer layers. The molecular weight of these molecules varies from 50 to a million, preferably from 50 to 10,000. Preferably these molecules are electrically charged. Examples of these molecules include, but are not limited to, surfactants, phosphates, bromates, sulfonates, tertiary amines, dyes, lipids and metal ions. Examples of the surfactants of the invention include, but are not limited to, Zonyl Surfactants (DuPont), SURFYNOI surfactant (Air product), FLUORAD (3M), sodium dodecylsulfonate (SDS), Dodecyltrimethylamonium bromide (DTAB).

Metal ions can also be used to form the coating on the hydrophilic areas of the inventions, in certain cases with more than one positive charges, and can form strong complex with organic functional groups such as, but not limited to, amino, carboxylic acid, thiol, sulfide, or disulfide groups.

5.2 Manufacture of Discrete Porous Materials

Discrete porous materials of this invention can be prepared using the methods described herein.

5.2.1 Direct Sintering of Polymer Powders

Sintering is a process that fuses discrete particles and/or substrates, such as polymer particles and substrates, together by heat. For example, polymer particles can be first packed in a mold or other containers or substrates. The particles are then heated to a temperature that usually melts only the outer surface or shell of the particles. The particles are then fused together at this temperature and cooled down to a lower temperature, such as room temperature, to form the sintered product. Many suitable sintering process of making a porous polymer can be used to form the sintered porous polymeric material of the present invention.

In one embodiment, polymer powders with different compositions are selectively laid on specific areas of a compression mold. The laid down polymer powders then are compress sintered into finished parts (FIG. 1). In the finished parts, some areas are hydrophilic and other regions are hydrophobic. The geography of the discrete hydrophilic and hydrophobic regions is determined by the powder position before the sintering. The resulting porous material may take the form of a billet, in which case the porous material may be optionally skived into sheets (FIG. 2).

Discrete hydrophilic and hydrophobic porous material can also be manufactured by selectively placing different powders on different locations of a mold. These different powders will provide different hydrophilicity after the sintering. After the sintering, the polymer powders would fuse into the substrate and form self-sustained porous plastic parts. These finished hydrophilic and hydrophobic discrete parts, if in the form of a billet, can be used as is or may further be skived into sheets or films. (FIG. 2).

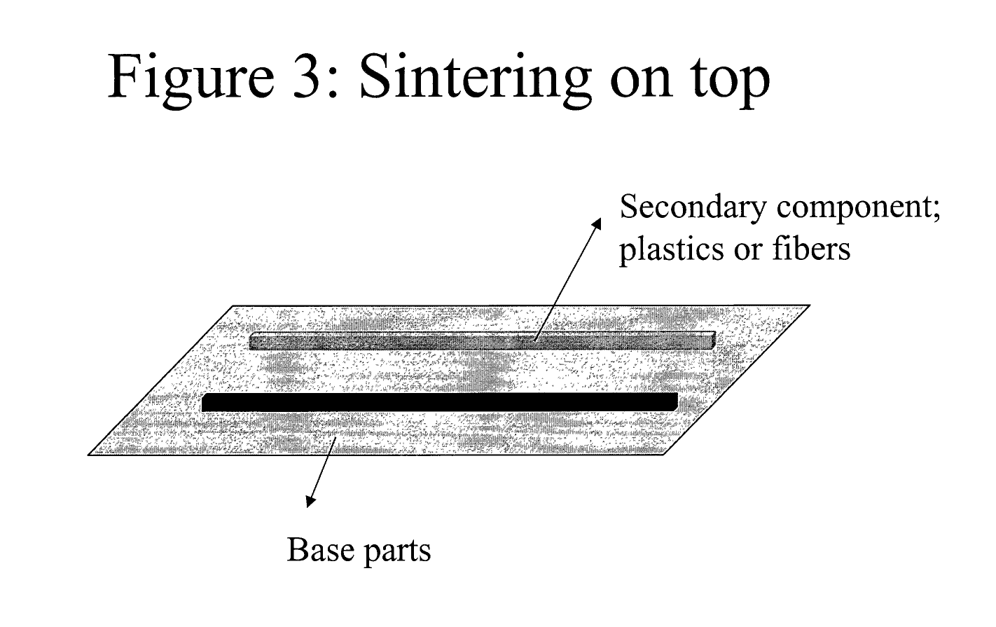

Discrete hydrophilic and hydrophobic porous material can also be manufactured by selectively placing hydrophilic powders on top of hydrophobic porous materials or other solid non-porous materials and sintering them under an elevated temperature. After the sintering, the hydrophilic polymer powders were fused together and form a single piece with the substrate materials. (FIG. 3).

After one or more of the sintering processes discussed herein, the discrete hydrophilic and hydrophobic regions may either have the same porosity and pore sizes or different porosity and pore sizes. Different porosity and pore sizes can be obtained on discrete areas of porous material by applying powders with different shapes and sizes to different discrete areas. Different porosity and pore sizes can also be achieved by using the same powder materials but applying different pressures on different discrete regions of the porous materials during or after the sintering process, or by adjusting the duration of sintering time.

Each discrete hydrophilic area can have the same kinds of porous materials and same wicking property. Each discrete hydrophilic area may have the same kind of porous material, but with different porosities, pore sizes and wicking properties. Further, each discrete hydrophilic area may also have different porous materials. For example, certain discrete areas may be made of polyethylene, while other discrete areas may be made of PTFE material. There are many combinations for the sinterable porous materials that can be used to manufacture discrete porous materials.

Those skilled in the art will recognize that the average pore size of the porous polymeric material will depend, at least in part, on the average particle size of the polymeric material, the sintering temperature, and the pressure, if any, applied to the mixture during sintering. For example, in most cases, if the particles of the other optional materials are smaller than the average pore size of the porous material, they will be trapped within pores of the material during the sintering process, and may be adhered to the walls of those pores. On the other hand, if particles of the other optional materials are larger than the average pore size of the porous material, they will be incorporated within the porous material as inclusions. In the case that the melting point of optional material is lower than that of the porous material, the optional material may coat the pores.

Sintering can occur on a solid support or within a mold to yield a final product that can be cut into pieces of desired shape. The use of molds is preferred where the desired shape of the self-sealing medium is complex.

5.2.2 Surface Activation

According to the present invention, the surface of a substrate can be activated using one or more methods known in the art such as, but not limited to, chemical treatment, plasma discharge, electron-beam discharge, corona discharge, and UV radiation. This activation alters the surface of the substrate (e.g., cleaving chemical bonds) to allow the formation of hydrophilic and/or chemically active moieties such as, but not limited to, hydroxy, amine, and carboxylic groups. As one of ordinary skill in the art understands, the particular functional groups formed will depend on the chemical composition of the substrate surface and the methods and conditions used to activate it. Often, the activation of a hydrophobic plastic surface usually provides a hydrophilic, electrically charged surface. High energy activation methods such as direct and remote plasma activation, corona discharge, electron beam, and UV radiation are preferred in this invention.

Plasmas that can be used to provide negatively charged porous plastic surfaces include, but are not limited to, plasmas of argon, oxygen, nitrogen, methanol, ethylene oxide, and acetone. Plasmas that can be used to provide positively charged surfaces include, but are not limited to, ammonia and ethylenediamine. Depending on the composition of the substrate, its size, and the particular plasma used, the time necessary to achieve a desired surface will vary. Typical times can vary from about 1 minute to about an hour. Similarly, the power necessary to achieve the desired plasma may vary from about 50 W to about 1000 W.

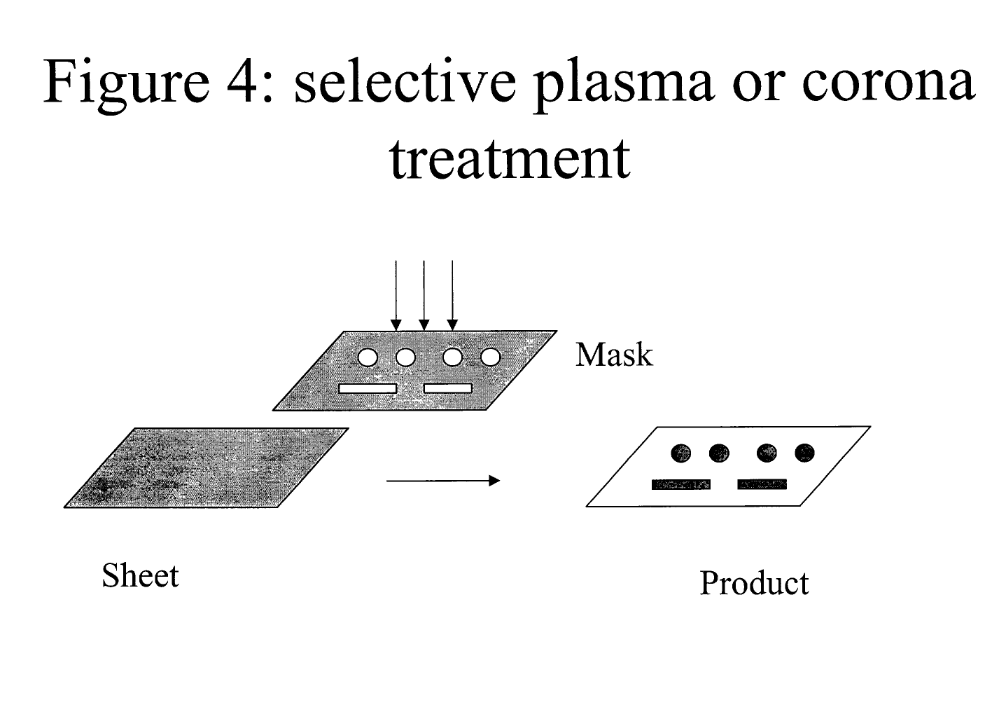

Creating discrete hydrophilic and hydrophobic areas on porous materials requires selectively blocking plasma radiation on the hydrophobic areas. After the plasma treatment, only the areas that have been exposed to the plasma discharge become hydrophilic and the areas that are blocked by, for example a mask, will retain their hydrophobic property (FIG. 4). The mask materials can be anything that can form tight contact with the porous materials and effectively block the ions and radicals from the plasma. These materials include, but are not limited to, metals, plastics, rubbers, and paper tapes. A specific mask material is polyester. For example, commercially available polyester tape such as, but is not limited to, Scotch® tape (3 M) can be used.

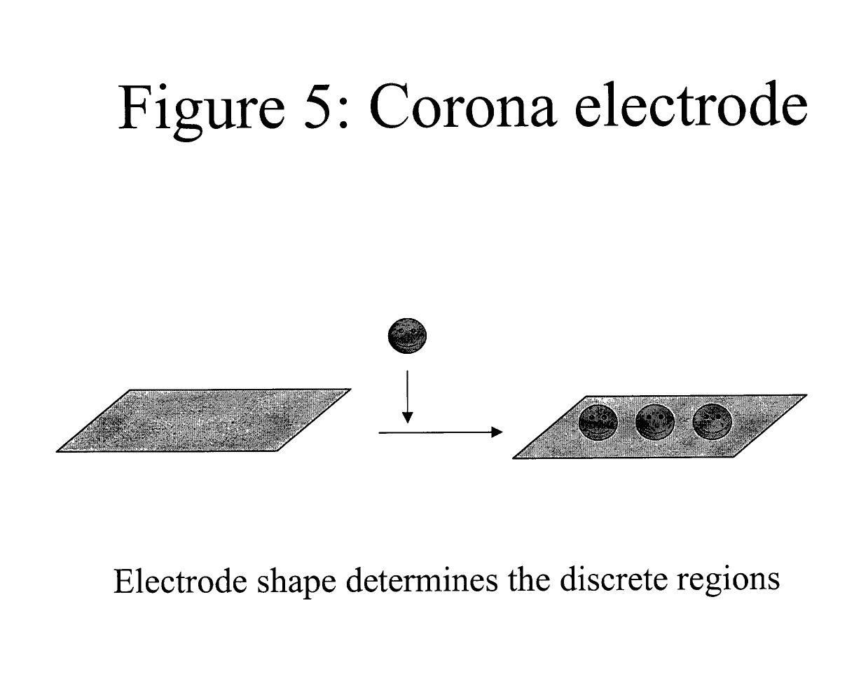

Corona discharges can also be used to manufacture discrete hydrophobic and hydrophilic porous materials. There are two different ways to manufacture discrete hydrophobic and hydrophilic porous materials using corona discharges. One is to apply a mask that contacts tightly with uniform porous materials, so that after the masked porous materials pass through the corona discharge area, only the unmasked parts of porous materials become hydrophilic (FIG. 4). The masked parts of porous materials will retain their hydrophobic property. Another way to manufacture discrete hydrophobic and hydrophilic porous material is by using specially designed electrodes. These electrodes are specially made to the shape that is identical to the geography of discrete hydrophobic and hydrophilic regions of the porous material. When the uniform porous materials pass the electrodes, the electrodes will make the porous materials right below them become hydrophilic. The areas not encompassed by the electrodes will still retain their hydrophobic property (FIG. 5).

Electron beam is another method that can be used for selectively activating discrete regions on porous materials. For selective activation, electron beam can simply be focused to specific areas of porous materials. The areas to which the electron beam is focused will become hydrophilic after the electron beam treatment. Areas not exposed to the electron beam will retain their original hydrophobicity.

5.2.3. Coating of the Activated Discrete Regions

After the uniform porous materials are selectively activated and discrete regions of hydrophilic and hydrophobic characteristics are formed, the discrete hydrophilic areas can be further enhanced or fixed by coating. Any methods of surface modification may be applied for this purpose. For example, treatment of the activated discrete regions by polyelectrolyte solutions may be employed. Likewise, method of coating the porous materials with functional additives, as disclosed in co-pending U.S. patent application Ser. No. 09/866,842, herein incorporated by reference, can also be used for certain purposes. Method of coating the porous substrates with various coating materials, as disclosed in co-pending U.S. patent application Ser. No. 10/228,944, herein incorporated by reference, can also be used.

5.2.3.1 Treatment by Polyelectrolyte Solutions

In a specific embodiment of the present invention, the discrete regions of the porous material of this invention may be subjected to sequential treatment by polyelectrolyte solutions. The substrate is contacted with a solution of the materials from which the first layer will be formed on the surface of the substrate. Specific suitable solutions are solutions of cationic or anionic polymers. The solutions can be aqueous, but organic solvents can also be used. Specific examples are solutions of water, ethanol, isopropanol, and mixtures thereof. The contact between the substrate and the solution is maintained for a sufficient time and at a sufficient temperature for the first layer to form on the substrate surface. Specifically, layers are formed by the formation of covalent bonds and/or electrostatic interactions between functional groups on the substrate surface and molecules in the solution.

The interactions between functional groups on the substrate surface and molecules in the solution can be adjusted by the type of solvent used, temperature, pH and the addition of coupling agents. For example, high pH and coupling agent concentration can promote covalent bond formation between the substrate and the first layer of coating.

After the resulting coated substrate is removed from the solution, it is washed with, for example, deionized water in an ultrasonic bath. Typical wash times will vary depending on the solvent and the materials used to form the first layer, but are often about 10 minutes or less. Optionally, the washed, single-layer coated substrate can be dried at an elevated or room temperature. Elevated temperature promotes formation of covalent bonds.

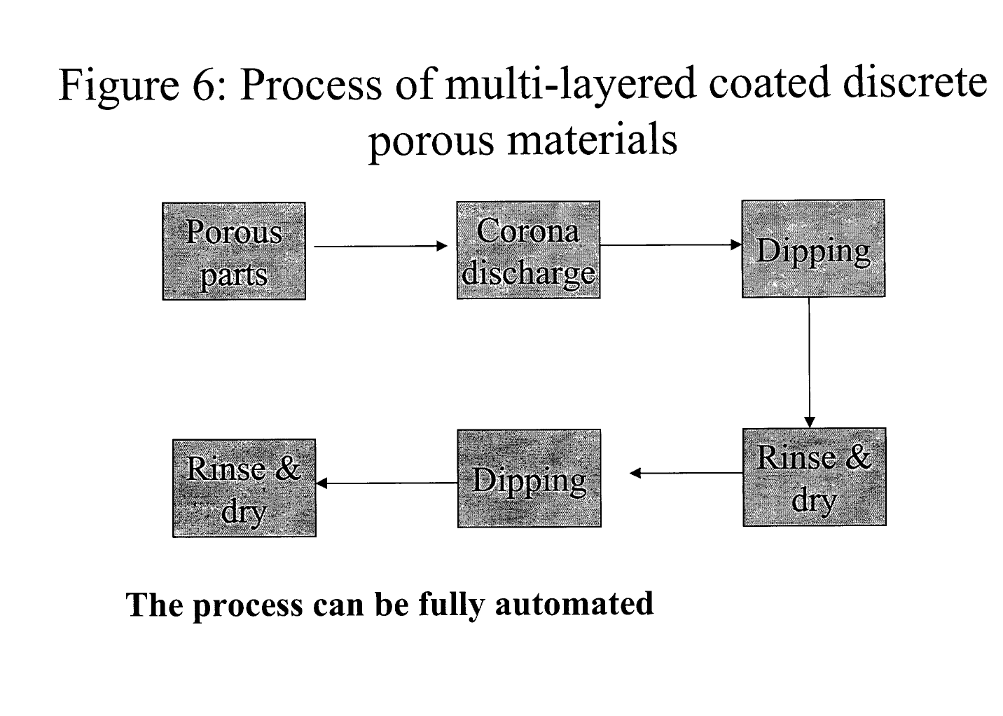

The single-coated substrate can then be contacted with a second solution. Preferably, this second solution is of molecules that are of an opposite charge to those that form the first layer so that the second layer adheres to the first via electrostatic interactions. However, the first layer can also be formed from molecules that have functional groups that, with or without activation, can react with functional groups on the molecules used to form the second layer. After the resulting dual-coated substrate is removed from the second solution, it is preferably washed and dried at room temperature or an elevated temperature. An illustration of the coating process is shown in FIG. 6.

Polyelectrolyte solutions having a concentration of about 10 ppm to about 100,000 ppm are typically used for the purpose of the present invention. As those of ordinary skill in the art will appreciate, the concentration of any particular solution depends on the polymer molecular weight, charge density and type of molecules from which a given layer is to be made. Solutions of higher molecular weight molecules generally require lower concentrations than those of lower molecular weight molecules. Similarly, high ionic density polymers typically require lower solution concentrations. For solutions such as PEI and PAA, specific concentrations are in the range of about 0.05% to about 2%, or about 0.1% to about 1%, in ethanol-water solution. Generally, biomolecules show high immobilization on a surface with opposite electric charges, particularly when the media is of low ionic strength.

Electrostatic interaction is one of the most important interactions between differently charged polyelectrolytes, especially during complex formation. Different polyelectrolytes can also form covalent bonds between their functional groups. For example, the amino group in PEI can form amide bond with the carboxylic acid group in PAA. The formation, strength, and durability of the covalent bonds also depend on the type of solvent, temperature, pH and presence and concentration of coupling agents. The ratio of PEI and PAA and the coupling agent will also have an effect on the percentage of covalent bond formed. Coupling reagents, such as dicyclohexylcarbodiimide (DCC) and 1-ethyl-3-(3-dimethylaminopropyl)carbodiimide (EDC), can be used to promote such reactions.

Examples of different coating scenarios include: electrostatic interactions between substrate and first layer and covalent bond between first layer and second layer; covalent bond between substrate and first layer and covalent bond between first and second layer; electrostatic interactions between substrate and first layer and electrostatic interactions between first and second layer; and mixed covalent bond and electrostatic interactions for both coatings. Because the molecules forming each layer can be bound to the material below it by multiple covalent and/or electrostatic interactions, typical materials of the invention have highly stable coatings that are resistant to delamination and/or dissociation. Furthermore, the high stability of the present invention's multilayer coating results in lower solubility of the coatings, and thus, provides coatings with low leaching.

The process of optionally activating a porous surface and contacting it with a solution of one or more compounds under conditions sufficient to form a layer on the surface can be repeated to achieve coating of multiple layers. Thus, multi-layer coating of varying thickness, density, and uniformity can be adhered to the discrete surfaces of variety of porous materials.

5.2.3.2 Porous Materials with Discrete Functional Groups in Different Areas

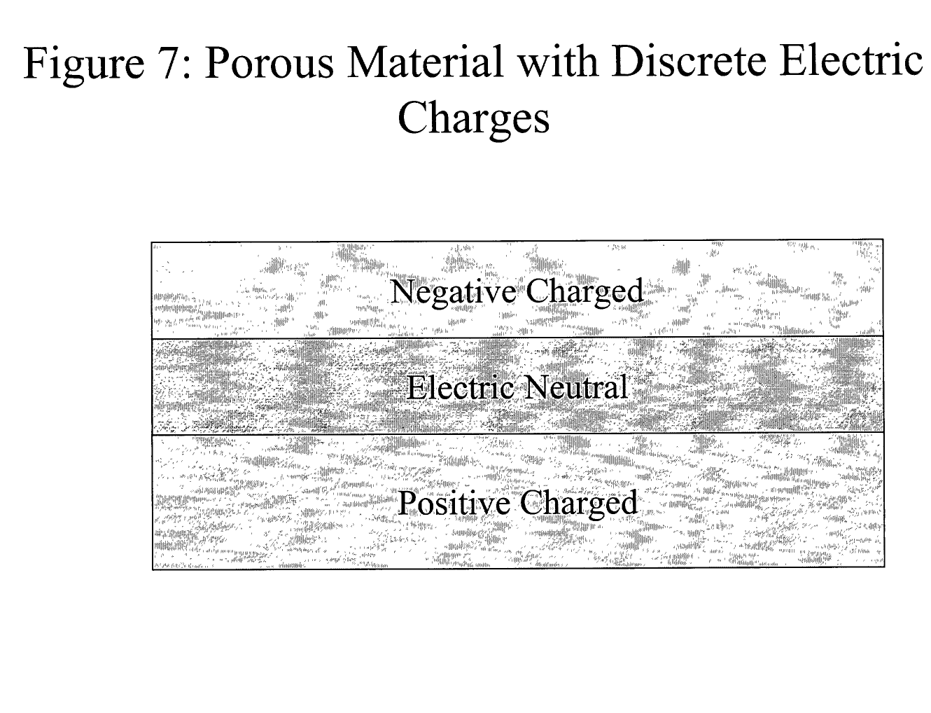

This invention also provides discrete porous materials substrates with a variety of chemically reactive functional groups (FIG. 7). The following variations can be achieved using the method of the present invention: each discrete hydrophilic area has the same kinds of reactive functional groups; each discrete hydrophilic area has the same chemically reactive functional groups, but different functional group density; and further, each discrete hydrophilic area may also have different chemically reactive functional groups.

By way of an example, functional groups that can be introduced onto discrete porous materials areas (e.g., porous plastics) include amino groups (including primary, secondary and tertiary amines), which are typically positively charged at neutral pH. Amino-functional discrete porous materials can be manufactured by any of the following methods: selectively activating porous material in amine containing (e.g., ammonia, ethyldiamine) plasma chamber or corona discharge environment; coating PEI or other amino group containing polyelectrolytes solutions on discrete activated hydrophilic area; or coating PEI or other amino group containing polyelectrolytes solutions to the discrete porous materials having negatively charged coating on them.

Carboxylic acid groups can be introduced onto porous materials by treating positively charged porous materials with PAA or other carboxylic acid containing polyelectrolytes solutions. Typically, positively charged materials have either been treated with a positively charged polyclectrolyte or have been activated in ammonia solution or ammonia plasma.

Sulfuric acid functional groups can be introduced onto porous materials by treating positively charged porous materials with poly(styrenesulfuric acid) (PSSA) or other sulfuric acid containing polyelectrolytes solutions. Typically, positively charged materials have either been treated with a positively charged polyelectrolyte or have been activated in ammonia solution or ammonia plasma.

PEG molecules can be coated onto charged porous materials by treating charged porous materials with PEG molecules that contain functional groups with opposite charges. For example, a PEG molecule having a carboxylic acid functional group can be coated onto a porous material coated with PEI.

Biomolecules can also be coated onto the substrates of this invention. For example, biotin, which is a small biomolecule that can specifically bind to avidin and streptavidin, can be introduced onto porous materials by treating charged porous materials with the biotin derivatives that contain opposite charges as compared to the porous materials.

Many polysaccharides contain electric charges and can provide good matrices for cell growth and harvesting. These charged polysaccharides, such as heparin, chitosan, and CMC, can be introduced onto porous materials by treating oppositely charged porous materials with the polysaccharides.

Fluoroalkyl groups, such as perfluoroalkyl groups, can be attached to porous materials by treating charged porous materials with fluoroalkyl molecules that contain opposite charges.

5.2.3.3 Porous Materials with Discrete Electric Charges in Different Areas

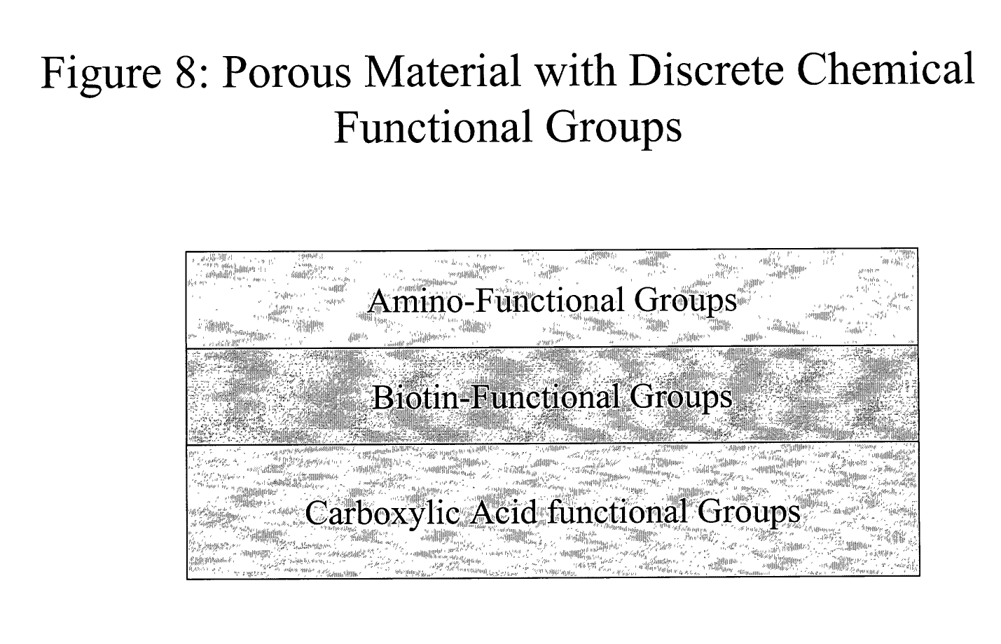

Methods of this invention can provide discrete porous materials substrates with a variety of electric charges and charge density (FIG. 8). Variations that can be achieved using the methods of the present invention include: porous materials wherein each discrete hydrophilic area has the same kind of electric charges; porous materials wherein each discrete hydrophilic area has the same electric charges, but different charge density; and porous materials wherein different discrete hydrophilic areas have different electric charges.

For example, positive charges can be introduced onto discrete porous material areas (e.g., porous plastics) by applying PEI solution treatment on specific areas. For the purpose of this invention, the concentration of PEI solution ranging from about 0.05% to about 1% is optimal. PEI coated porous materials are typically positively charged at neutral pH. Negative charges can be introduced onto discrete porous material areas (e.g., porous plastics) by applying PAA solution treatment on specific area. For the purpose of this invention, the concentration of PAA solution ranging from about 0.05% to about 1% is optimal. PAA coated porous materials are typically negatively charged at neutral pH. Neutral electric charges can be introduce to porous material by applying neutral or amphoteric (e.g., peptides) polymers to make porous materials with neutral electric charge at neutral pH.

5.2.4 Three-Dimensional Porous Materials

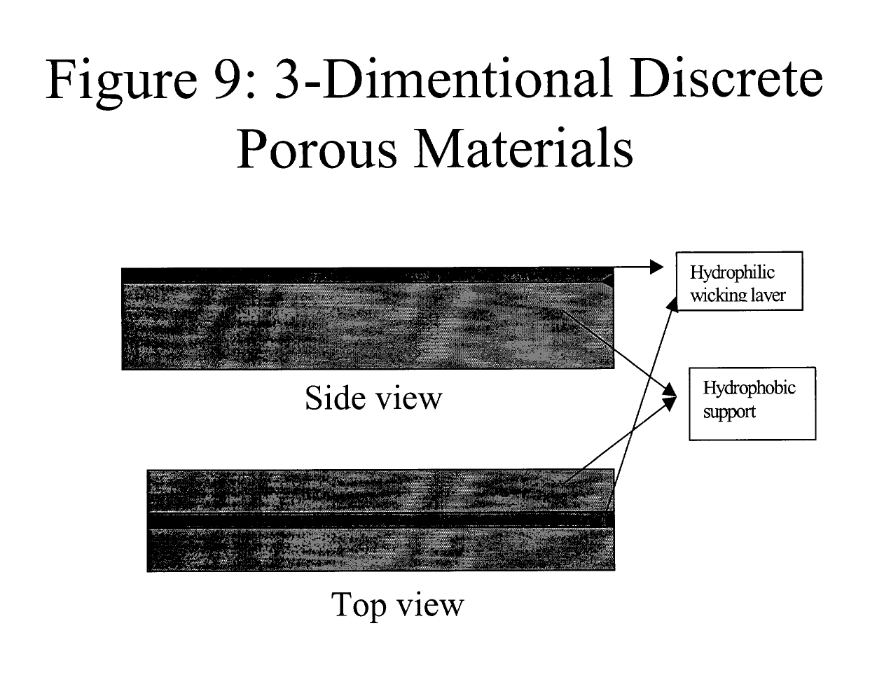

Discrete porous parts in the invention can also be in the z-direction, or combination of x-y-z direction (FIG. 9). Certain parts of porous material depth would have different hydrophilicity, porosity, pore sizes, functional groups and electric charges than other parts of the depth. Any methods of making discrete porous materials disclosed herein can be applied to manufacture three-dimensional porous materials. In making three-dimensional discrete porous materials, the activation energy of plasma, corona and electron beam must be controlled to limit the penetration depth of discharges. The conditions for controlling the activation energy vary with the materials and can be readily determined by the persons of ordinary skill in the art.

5.2.5 Applications of Discrete Porous Materials

Materials of the present invention have a wide variety of applications. Without limitations, the applications of the discrete porous materials of the present invention include: liquid and chemical delivery; microfluidic devices; lateral flow devices; flow through devices; filtration devices; solid state synthesis devices; extraction devices; cell growth devices; and implant materials. The areas of the application include, but are not limited to: immunoassay; diagnostics; medical devices; separation and purification; fast screening; combinatory chemistry; pregnancy, HIV, and drug abuse tests; and cell biology.

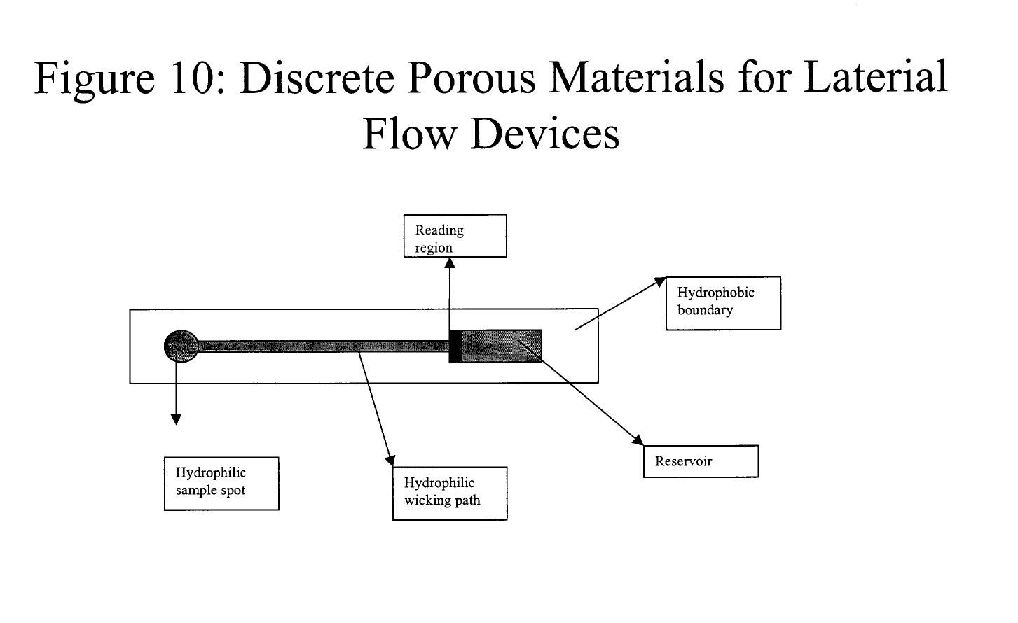

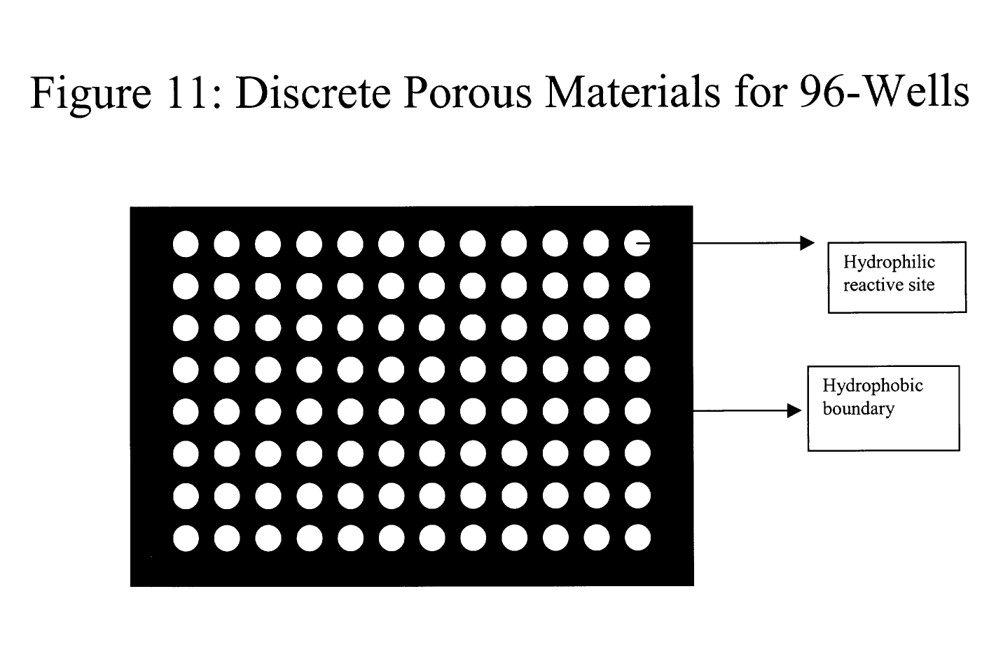

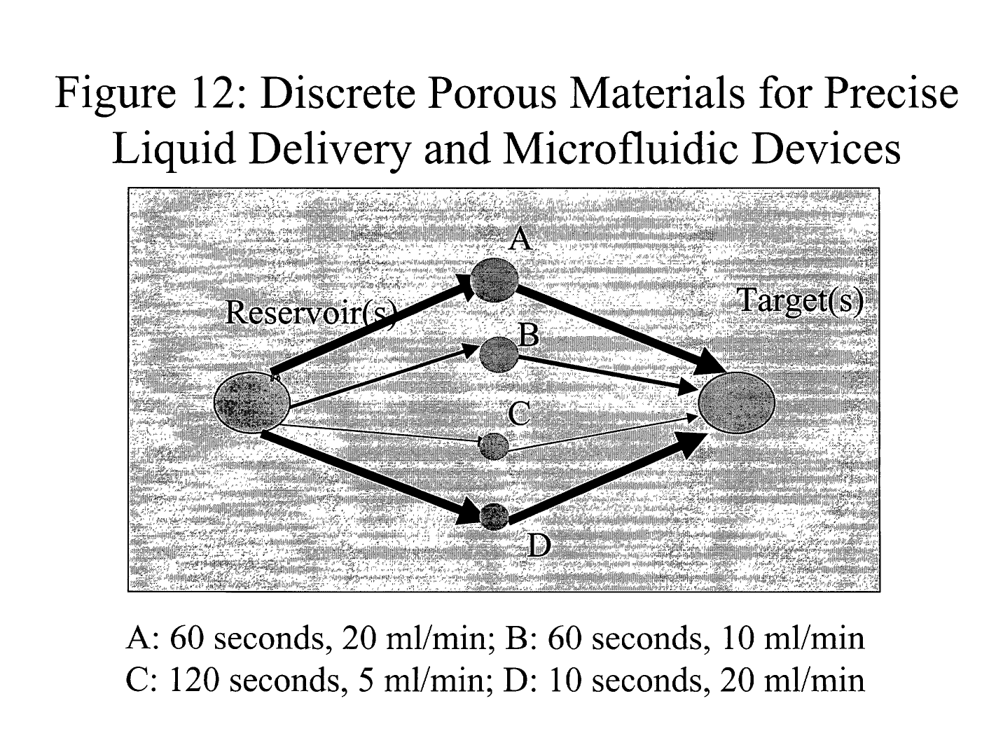

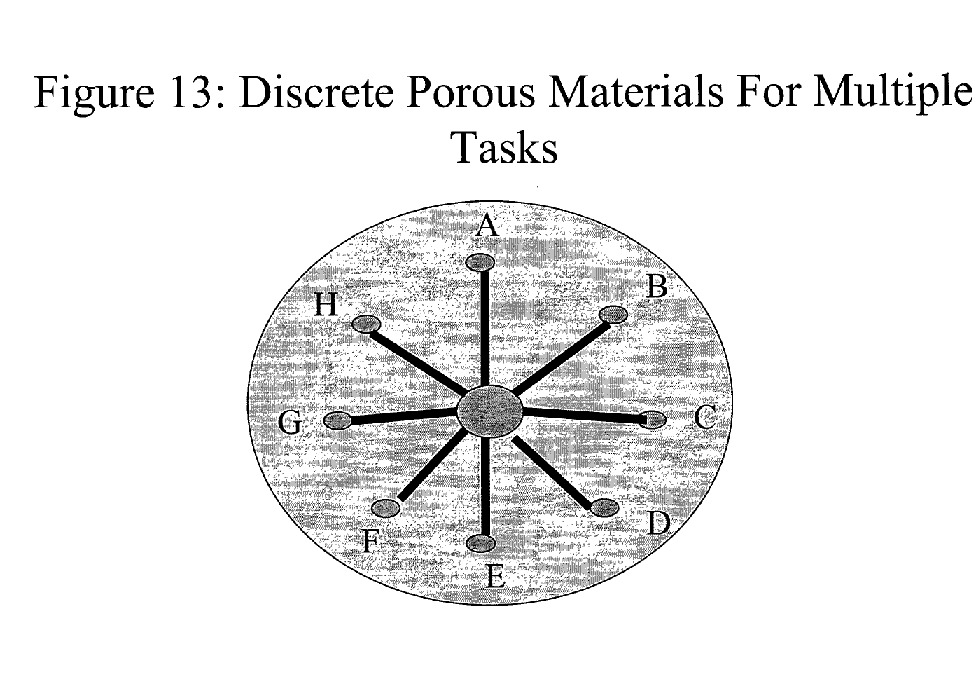

Illustrations of some of the applications are shown in figures as follows: FIG. 10 illustrates an application of discrete porous materials of this invention in a single piece lateral flow diagnostic device; FIG. 11 shows an application of discrete porous materials of this invention in discrete reactive zones containing 96 wells; FIG. 12 shows an application of discrete porous materials of this invention in liquid and chemical delivery systems or microfluidic devices, wherein the liquids can be delivered from beginning spot to the destination through different routes with different time, rates and chemicals; and FIG. 13 illustrates an application of discrete porous materials of this invention in multi-channel lateral flow devices. These figures are provided for illustration purpose only. It will be readily apparent to the person of ordinary skill in the art that numerous variations can be contemplated and/or practiced without departing from the scope and spirit of the present invention.

### 6. EXAMPLES

Certain embodiments of this invention, as well as certain advantages of this invention, are illustrated by the following non-limiting examples. Although limited number of examples are disclosed herein, it will be apparent to those skilled in the art that many modifications, both to materials and methods, may be practiced without departing from the purpose and interest of this invention.

6.1 One Step Sintering Discrete Hydrophilic-Hydrophobic Porous Sheet Materials

Polymer powder A (UHMW, polyethylene) and Powder mixture B (UHMW, polyethylene, wicking reagent) were laid down to a compression mold at a stripes with width of 1 cm alternatively. The laid down polymer powders were sintered at an elevated temperature and single porous plastic sheet was resulted. In this single plastic porous sheet, the area of polymer powder A was hydrophobic and the area of polymer powder B was hydrophilic (FIG. 1).

6.2 Sintering Discrete Hydrophilic-Hydrophobic Porous Billet Materials and Skiving into Discrete Sheet Materials

Polymer powder A (UHMW, polyethylene) and Powder mixture B (UHMW, polyethylene, wicking reagent) were selectively loaded to a 12 inch high and 5 inch diameter round column shape mold. The column was divided equally to 8 sections along the axis with a solid polymer sheet (0.2 cm thick). The powder A and powder B were loaded to the column mold alternatively. The solid polymer strips can be either removed from or remain inside the mold. The polymer powders inside the mold were then sintered at an elevated temperature and single porous plastic billet was resulted. The billet was then skived into thin sheet. The resulting sheet had discrete hydrophilic-hydrophobic areas.

The area of polymer powder A became hydrophobic and the area of polymer powder B became hydrophilic (FIG. 2). If solid non-porous boundary was not removed, the resulting materials could also contain discrete porous and non-porous regions.

6.3 One Step Sintering Molded Parts With Discrete Hydrophilic and Hydrophobic Areas

Polymer powder A (UHMW, polyethylene, 60 micron) and Powder mixture B (UHMW, polyethylene, 120 micron, wicking reagent) were selectively loaded to a 1 inch high and 0.5 inch diameter round column shape mold. The column was packed with 0.8 inch of powder B at the bottom and 0.2 inch of powder A on the top. The polymer powders inside the mold were then sintered at an elevated temperature. The resulting part had discrete hydrophilic-hydrophobic areas. The area of polymer powder A on the top 0.2 inch became hydrophobic and had a smaller pore size. The area of polymer powder B at the bottom 0.8 inch became hydrophilic and had a larger pore size.

6.4 Manufacture of Discrete Hydrophilic-Hydrophobic Porous Materials by Selective Plasma Treatment

A sintered porous plastic sheet (T3, Porex Corporation, 0.4 mm thick) was tightly covered with a polyester tape (Scotch® tape, 3 M) mask on both sides of the plastic sheet. The covered porous plastic sheet was then exposed to a treatment with oxygen plasma (EUROPLASMA, CD 600PC) at 100 watt, 120 mm Hg for 15 minutes until the uncovered part porous plastic became hydrophilic. The masks were then removed from the porous plastic sheet. The resulting porous plastic sheet had the discrete hydrophilic and hydrophobic regions. The regions that were covered by polyester tape masks remained hydrophobic and uncovered regions became hydrophilic.

6.5 Manufacture of Discrete Hydrophilic-Hydrophobic Porous Materials by Selective Corona Discharge Treatment

A sintered porous plastic sheet (T3, Porex Corporation, 0.4 mm thick) was tightly covered with a polyester tape (Scotch® tape, 3 M) mask on both sides of porous plastic sheet. The covered porous plastic sheet was then exposed to corona discharge (Corotech) for a period of time until the uncovered part of the porous plastic became hydrophilic. The masks were then removed from the porous plastic. Discrete hydrophilic and hydrophobic regions resulted on the porous plastic. The regions that were covered by polyester tape remained hydrophobic, whereas uncovered regions became hydrophilic.

In another experiment, corona discharge was directly applied to porous plastic sheet without using a mask. The electrodes used in corona discharge were made in variety of shapes and the electrode shapes could be directly transferred to generate hydrophilic regions on porous plastic sheet by applying electrode in the right position. In this case, only parts of the porous plastic right underneath the electrodes became hydrophilic (FIG. 5). A bar shaped corona electrode (0.5×5 cm, 100 watt) was positioned 1 mm above Porex porous plastic sheet and discharged for 10 seconds to make the part of the porous plastic that was directly underneath the electrode hydrophilic. The process is a stop and go process.

6.6 Manufacture of Discrete Hydrophilic-Hydrophobic Porous Materials by Selective Electron Beam Treatment

A sintered porous plastic sheet (T3, Porex Corporation, 0.4 mm thick) is selectively exposed to electron beam for a period of time until the regions that are exposed the electron beam radiation become hydrophilic. The regions that are not exposed to the electron beam radiation remain hydrophobic. The geography of electron beam treatment determines the geographic shape of discrete hydrophilic-hydrophobic regions.

6.7 Manufacture of Discrete Hydrophilic-Hydrophobic Porous Materials by Selective Plasma and Multi-Layer Coating Treatment

A sintered porous plastic sheet (T3, Porex Corporation, 0.4 mm thick) was tightly covered with a polyester tape (Scotch® tape, 3 M) mask on both sides of porous plastic sheet. The covered porous plastic sheet was then exposed to oxygen plasma (EUROPLASMA, CD 600PC) at 100 watt, 120 mm Hg for 15 minutes until the uncovered part porous plastic became hydrophilic. The masks were then removed from the porous plastic. The treated porous plastic had the discrete hydrophilic and hydrophobic regions. The regions that were covered by polyester tape remained hydrophobic and uncovered regions became hydrophilic.

The plasma treated discrete hydrophilic-hydrophobic porous plastic sheet was then immersed into 0.5% of PEI (BASF, MW 750,000) ethanol-water solution for 10 minutes. The coated sheet was then rinsed with deionized water in an ultrasonic bath (VWR) at room temperature for 5 minutes. This washing was repeated three times. The treated sheet can be optionally dried in the air. The rinsed porous plastic sheet was then immersed into 0.5% PAA (Aldrich, 523925, MW 250,000) ethanol-water solution for 10 minutes. The coated sheet was washed with 100 times volume of water in an ultrasonic bath (VWR) at room temperature for 5 minutes. This washing was repeated three times. The treated sheet was dried at room temperature. After the treatment, the regions that were exposed to the plasma became permanently hydrophilic and the regions that were not exposed to the plasma remained hydrophobic.

6.8 Manufacture of Discrete Hydrophilic-Hydrophobic Porous Materials by Selective Corona Discharge and Multi-Layer Coating Treatments

A sintered porous plastic sheet (T3, Porex Corporation, 0.4 mm thick) was tightly covered with a polyester tape (Scotch® tape, 3 M) mask on both sides of porous plastic sheet. The covered porous plastic sheet was then exposed to corona discharge at 200 watt until the uncovered part of the porous plastic became hydrophilic. The masks were then removed from the porous plastic. The resulting porous plastic had the discrete hydrophilic and hydrophobic regions. The regions that were covered by polyester tape remained hydrophobic and uncovered regions became hydrophilic.

The corona discharge treated discrete hydrophilic-hydrophobic porous plastic sheet was then immersed into 0.5% of PEI (BASF, MW 750,000) ethanol-water solution for 10 minutes. The coated sheet was then rinsed with deionized water in an ultrasonic bath (VWR) at room temperature for 5 minutes. This washing was repeated three times. The treated sheet can be optionally dried in the air. The rinsed porous plastic sheet was then immersed into 0.5% PAA (Aldrich, 523925, MW 250,000) ethanol-water solution for 10 minutes. The coated sheet was washed with 100 times volume of water in an ultrasonic bath (VWR) at room temperature for 5 minutes. This washing was repeated three times. The treated sheet was dried at room temperature. After the treatment, the regions that were exposed to corona discharge became permanently hydrophilic and the regions that were not exposed to corona discharge remained hydrophobic.

6.9 Manufacture of Discrete Hydrophilic-Hydrophobic Porous Materials by Selective Electron Beam and Multi-Layer Coating Treatments

A sintered porous plastic sheet (T3, Porex Corporation, 0.4 mm thick) is exposed to electron beam radiation until the porous plastic becomes hydrophilic. The untreated regions remain hydrophobic. The geography of electron beam treatment determines the geographic shape of discrete hydrophilic-hydrophobic regions.

The electron beam treated discrete hydrophilic-hydrophobic porous plastic sheet is then immersed into 0.5% of PEI (BASF, MW 750,000) ethanol-water solution for 10 minutes. The coated sheet is then rinsed with deionized water in an ultrasonic bath (VWR) at room temperature for 5 minutes. This rinsing is repeated three times. The treated sheet can be optionally dried in the air. The rinsed porous plastic sheet is then immersed into 0.5% PAA (Aldrich, 523925, MW 250,000) ethanol-water solution for 10 minutes. The coated sheet is washed with 100 times volume of water in an ultrasonic bath (VWR) at room temperature for 5 minutes. This washing is repeated three times. The treated sheet is dried at room temperature. After the treatment, the regions that are exposed to electron beam become permanently hydrophilic and the regions that are not exposed to electron beam remain hydrophobic.

6.10 Manufacture of Discrete Hydrophobic-Oleophobic Porous Materials by Selective Plasma and Multi-Layer Coating Treatments

A sintered porous plastic sheet (T3, Porex Corporation, 0.4 mm thick) was tightly covered with a polyester tape (Scotch® tape, 3 M) mask on both sides of porous plastic sheet. The covered porous plastic sheet was then exposed to oxygen plasma (EUROPLASMA, CD 600PC) at 100 watt, 120 mm Hg for 15 minutes until the uncovered part porous plastic became hydrophilic. The masks were then removed from the porous plastic. The resulting porous plastic had the discrete hydrophilic and hydrophobic regions. The regions that were covered by polyester tape remained hydrophobic and uncovered regions became hydrophilic.

Discrete hydrophilic and hydrophobic porous plastic sheet was then immersed into 0.5% of PEI (BASF, MW 750,000) ethanol-water solution for 10 minutes. The coated sheet was then rinsed with deionized water in an ultrasonic bath (VWR) at room temperature for 5 minutes. This washing was repeated three times and the porous plastic sheet was optionally dried in the air. The hydrophilic regions of discrete porous plastic were then coated with PEI.

The PEI coated discrete porous plastic sheet was then immersed into 0.5% of FSP fluorinated surfactants (DuPont) ethanol-water solution for 10 minutes. The coated sheet was washed with deionized water in an ultrasonic bath (VWR) at room temperature for 5 minutes. This washing was repeated three times. The treated sheet was dried at room temperature. The PEI coated regions, which were hydrophilic after the plasma treatment then became oleophobic.

6.11 Manufacture of Discrete Hydrophobic-Oleophobic Porous Materials by Selective Corona Discharge and Multi-Layer Coating Treatments

A sintered porous plastic sheet (T3, Porex Corporation, 0.4 mm thick) was tightly covered with a polyester tape (Scotch® tape, 3 M) mask on both sides of porous plastic sheet. The covered porous plastic sheet was then exposed to corona discharge at 200 watt until the uncovered part of the porous plastic became hydrophilic. The masks were then removed from the porous plastic. The resulting porous plastic had the discrete hydrophilic and hydrophobic regions. The regions that were covered by polyester tape remained hydrophobic and uncovered regions became hydrophilic.

The corona discharge treated discrete hydrophilic-hydrophobic porous plastic sheet was then immersed into 0.5% of PEI (BASF, MW 750,000) ethanol-water solution for 10 minutes. The coated sheet was then rinsed with deionized water in an ultrasonic bath (VWR) at room temperature for 5 minutes. This washing was repeated three times. The treated sheet can be optionally dried in the air. The rinsed porous plastic sheet was then immersed into 0.5% of FSP fluorinated surfactants (DuPont) ethanol-water solution for 10 minutes. The coated sheet was washed with deionized water in an ultrasonic bath (VWR) at room temperature for 5 minutes. This washing was repeated three times. The treated sheet was dried at room temperature. The PEI coated regions, which were hydrophilic after corona discharge treatment then became oleophobic.

6.12 Manufacture of Discrete Hydrophobic-Hydrophilic and Discrete Charged Porous Materials by Selective Plasma and Multi-Layer Coating Treatments

After porous plastic sheet was pre-activated by plasma discharge as disclosed in example 6.4, certain hydrophilic regions (Region As) were treated with positively charged polyelectrolyte solution (i.e., 0.5% of PEI (BASF, MW 750,000) ethanol-water solution for 10 minutes), and other hydrophilic regions (Region Bs) were treated with negatively charged polyelectrolyte solution (i.e., 0.5% PAA (Aldrich, 523925, MW 250,000) ethanol-water solution for 10 minutes). The discrete porous plastic sheet was then washed and dried. The region As were positively charged (positive ξ potential); the region Bs were negatively charged (negative ξ potential); and hydrophobic regions on discrete porous materials were neutral at neutral pH condition.

Region As, which were treated with positively charged polyelectrolyte solution (i.e., PEI) can then be sequentially treated with a negatively charged polyelectrolyte solution (i.e., PAA). The region As became negatively charged (negative ξ potential). In a similar way, Region Bs, which were treated with negatively charged polyelectrolyte solution (i.e., PAA) could then be sequentially treated with a positively charged polyelectrolyte solution (i.e., PEI). The region Bs became positively charged (positive ξ potential). The above selective polyelectrolyte solution treatment can be repeated several times until the desired film thickness or charge density is achieved.

6.13 Manufacture Of Discrete Hydrophobic-Hydrophilic and Discrete Charged Porous Materials by Selective Corona Discharge and Multi-Layer Coating Treatments

After porous plastic sheet was pre-activated by corona discharge as disclosed in examples 6.5, certain hydrophilic regions (Region As) were treated with positively charged polyelectrolyte solution (i.e., 0.5% of PET (BASF, MW 750,000) ethanol-water solution for 10 minutes), and other hydrophilic regions (Region Bs) were treated with negatively charged polyelectrolyte solution (i.e., 0.5% PAA (Aldrich, 523925, MW 250,000) ethanol-water solution for 10 minutes). The discrete porous plastic sheet was then washed and dried. The region As were positively charged (positive ξ potential); the region Bs were negatively charged (negative ξ potential); and hydrophobic regions on discrete porous materials were neutral at neutral pH condition.

Region As, which were treated with positively charged polyelectrolyte solution (i.e., PEI) can then be sequentially treated with a negatively charged polyelectrolyte solution (i.e., PAA). Region As became negatively charged (negative ξ potential). In a similar way, Region Bs, which were treated with negatively charged polyelectrolyte solution (i.e., PAA) could then be sequentially treated with a positively charged polyelectrolyte solution (i.e., PEI). Region Bs became positively charged (positive ξ potential). The above selective polyelectrolyte solution treatment can be repeated several times until the desired film thickness or charge density is achieved.

6.14 Manufacture of Porous Materials Containing Discrete Hydrophobic-Hydrophilic Regions and Discrete Chemical Functional Groups by Selective Plasma and Multi-Layer Coating Treatments

After porous plastic sheet was pre-activated by plasma discharge as disclosed in example 6.4, certain hydrophilic regions (Region As) were treated with polyelectrolytes that contain amino-functional groups (i.e., 0.5% of PEI (BASF, MW 750,000) ethanol-water solution for 10 minutes), and other hydrophilic regions (Region Bs) were treated with polyelectrolytes that contain carboxylic functional groups (i.e., 0.5% PAA (Aldrich, 523925, MW 250,000) ethanol-water solution for 10 minutes). The discrete porous plastic sheet was then washed and dried. The region As were amino group functionalized; the region Bs were carboxylic acid group functionalized; and hydrophobic regions are chemically inert with hydrocarbon backbones.

Region As, which were treated with amino functional polyelectrolyte (i.e., PEI) can then be sequentially treated with a negatively charged molecules that contains other functional groups to provide region As with variety of functional groups. PEI coated regions can then be treated with: PAA to provide carboxylic acid groups; poly(vinyl sulfate) to provide sulfate groups; phosphate containing molecules to provide phosphate groups (i.e., lipids, molecules containing both phosphate and carboxylic acid); biotin containing negative charge molecules to provide biotin functional groups (i.e., carboxylic functional biotin, Shearwater); thiol containing negative charge molecules to provide thiol groups (i.e., β-mercaptoacetic acid); or peptides that have free carboxylic acid groups; or nucleic acids containing phosphate groups (i.e., DNA and RNA fragments containing phosphate groups).

In a similar way, the region Bs, which were treated with negatively charged polyelectrolyte solution (i.e., PAA) can then be sequentially treated with functional groups or molecules that contain positive charges to provide region Bs with variety of functional groups.

6.15 Manufacture of Porous Materials Containing Discrete Hydrophilic-Hydrophobic Regions and Discrete Chemical Functional Groups by Selective Corona Discharge and Multi-Layer Coating Treatment

After porous plastic sheet was pre-activated by corona discharge as disclosed in examples 6.5, certain hydrophilic regions (Region As) were treated with polyelectrolytes that contain amino-functional groups, (i.e., 0.5% of PET (BASF, MW 750,000) ethanol-water solution for 10 minutes), and other hydrophilic regions (Region Bs) were treated with polyelectrolytes that contain carboxylic functional groups, (i.e., 0.5% PAA (Aldrich, 523925, MW 250,000) ethanol-water solution for 10 minutes). The discrete porous plastic sheet was then washed and dried. The region As were amino group functionalized; the region Bs were carboxylic acid group functionalized; and hydrophobic regions are chemically inert with hydrocarbon backbones.

Region As, which were treated with amino functional polyelectrolyte (i.e., PEI) can then be sequentially treated with a negatively charged molecules that contains other functional groups to provide region As with variety of functional groups. PEI coated regions can then be treated with: PAA to provide carboxylic acid groups; poly(vinyl sulfate) to provide sulfate groups; phosphate containing molecules to provide phosphate groups (i.e., lipids, molecules containing both phosphate and carboxylic acid); biotin containing negative charge molecules to provide biotin functional groups (i.e., carboxylic functional biotin, Shearwater); thiol containing negative charge molecules to provide thiol groups (i.e., β-mercaptoacetic acid); or peptides that have free carboxylic acid groups; or nucleic acids containing phosphate groups (i.e., DNA and RNA fragments containing phosphate groups).

In a similar way, the region Bs, which were treated with negatively charged polyelectrolyte solution (i.e., PAA) can then be sequentially treated with functional groups or molecules that contain positive charges to provide region Bs with variety of functional groups.

What is claimed is:

1. A porous polymeric material comprising a surface, wherein said polymeric material is a single piece and wherein said surface comprises a plurality of discrete regions that exhibit distinct surface properties.

2. The material of claim 1, wherein the polymeric material is selected from a group consisting of polyolefin, polyether, polyurethane, polycarbonate, polyetheretherketone, poly(phenylene oxide), poly(ether sulfone), polysulfone, nitrocellulose, cellulose, fluorinated polymers, PTFE, porous fiber materials or nylon.

3. The material of claim 2, wherein the polyolefin is selected from a group consisting of ethylene vinyl acetate, ethylene methyl acrylate, polyethylene, polypropylene, ethylene-propylene rubber, ethylene-propylene-diene rubbers, poly(1-butene), polystyrene, poly(2-butene), poly(1-pentene), poly(2-pentene), poly(3-methyl-1-pentene), poly(4-methyl-1-pentene), 1,2-poly-1,3-butadiene, 1,4-poly-1,3-butadiene; polyisoprene, polychloroprene, poly(vinyl acetate), poly(vinylidene chloride), poly(vinylidene fluoride), poly(tetra fluoro ethylene), or mixtures thereof.

4. The material of claim 1, wherein the surface properties are one or more of hydrophilicity, hydrophobicity, oleophobicity, biological molecules binding capability, wetting and wicking property, presence or density of functional groups, chemical reactivity, electronic charges, porosity, and pore sizes.

5. The material of claim 1, wherein the discrete surface properties are hydrophobic and hydrophilic.

6. The material of claim 5, wherein the discrete hydrophilic regions are surrounded by hydrophobic boundaries.

7. The material of claim 5, wherein the discrete hydrophobic regions are surrounded by hydrophilic boundaries.

8. The material of claim 1, wherein the discrete surface properties are hydrophobic and oleophobic.

9. The material of claim 1, wherein all discrete regions exhibit the same surface property.

10. The material of claim 1, wherein different discrete regions exhibit different surface properties.

11. The material of claim 1, wherein the discrete regions have been coated with one or more layers of coating materials.

12. The material of claim 11, wherein a first layer of the coating materials is bound to the discrete regions by covalent bonds, electrostatic interactions, or combination thereof and a second layer of the coating materials is bound to the first layer by covalent bonds, electrostatic interactions, or combination thereof.

13. The material of claim 11, wherein the coating material is polyelectrolyte, neutral polymer, small molecule, biomolecule, or combination thereof.

14. The material of claim 13, wherein the polyelectrolyte is a phosphate, polyethyleneimide, poly(vinylimidazoline), quaterized polyacrylamide, carboxyl modified polyacryl amide, polyvinylpyridine, poly(vinylpyrrolidone), polyvinylamine, polyallylamine, chitosan, polylysine, poly(acrylate trialkyl ammonia salt ester), cellulose, poly(acrylic acid), polymethylacrylic acid, poly(maleic acid), poly(styrenesulfuric acid), poly(vinylsulfonic acid), poly(toluene sulfuric acid), poly(methyl vinyl ether-alt-maleic acid), poly(glutamic acid), surfactant, Nafion® (DuPont), dextran sulfate, hyaluric acid, heparin, alginic acid, adipic acid, chemical dye, protein, enzyme, nucleic acid, peptide, or a salt, ester, and/or copolymer thereof.

15. The material of claim 13, wherein the neutral polymer is isocyannated terminated polymer, epoxy-terminated polymer, or hydroxylsuccimide terminated polymer.

16. The material of claim 15, wherein the neutral polymer is polyurethane, poly(ethylene glycol), and polysiloxane.

17. The material of claim 13, wherein the small molecule is sodium dodecylsulfonate, dodecyltrimethylamonium bromide, phosphate, sulfonate, bronate, sulfonate, dye, lipid, metal ion, or surfactant containing fluorine.

18. The material of claim 13, wherein the biomolecule is a protein, an enzyme, a lipid, a hormone, a peptide, a nucleic acid, an oligonucleic acid, a DNA, an RNA, a sugar, or a polysaccharide.

19. The material of claim 1, wherein the porous material has electric charges in discrete regions.

20. The material of claim 19, wherein all discrete regions have the same electric charges.

21. The material of claim 19, wherein different discrete regions have different electric charges.

22. The material of claim 20 or 21, wherein the discrete regions have varying charge densities.

23. The material of claim 1, wherein the porous material has chemical functional groups in discrete regions.

24. The material of claim 23, wherein all discrete regions have the same chemical functional groups.

25. The material of claim 23, wherein different discrete regions have different chemical functional groups.

26. The material of claim 24 or 25, wherein the discrete regions have varying densities of chemical functional groups.

27. The material of claim 23, wherein the functional group is an amino group.

28. The material of claim 23, wherein the functional group is carboxylic acid.

29. The material of claim 23, wherein the functional group is sulfuric acid.

30. The material of claim 23, wherein the functional group is a polysaccharide.

31. The material of claim 23, wherein the functional group is a perfluoroalkyl group.

32. The material of claim 1, wherein the discrete regions are three-dimensionally located.

33. A method of making porous materials having a plurality of discrete regions that exhibit distinct surface properties comprising, arranging polymer particles with different properties in a predetermined pattern and compress sintering the arranged particles into a porous material.

34. The method of claim 33, wherein the resulting porous material is in the form of a billet.

35. The method of claim 34, wherein the billet porous material is skived into one or more sheets.

36. The method of claim 33, 34 or 35, wherein the resulting porous material has hydrophilic and hydrophobic regions.

37. A method of making porous materials having a plurality of discrete regions that exhibit distinct surface properties comprising, providing a porous substrate, selectively placing polymer powders on discrete regions on the substrate, and compress sintering the polymer powders into the substrate.

38. The method of claim 37, wherein the same polymer powders are used on all discrete regions.

39. The method of claim 37, wherein the polymer powders consist of different polymers to provide discrete regions of different surface properties.

40. The method of claim 37, wherein the hydrophilic polymer powders are sintered into hydrophobic porous substrates to provide discrete hydrophilic-hydrophobic regions.

41. The method of claim 37, wherein the resulting porous material has the same porosity or pore sizes in all discrete regions.

42. The method of claim 37, wherein the resulting porous material has different porosity or pore sizes in different discrete regions.

43. A method of making porous materials having a plurality of discrete regions that exhibit distinct surface properties, comprising: providing a porous substrate; and selectively activating discrete regions of the substrate.

44. The method of claim 43, wherein the selective activation is achieved by high energy activation.

45. The method of claim 44, wherein the high energy activation is direct plasma activation or remote plasma activation.

46. The method of claim 44, wherein the high energy activation is UV radiation.

47. The method of claim 44, wherein the high energy activation is corona discharge.

48. The method of claim 45, 46 or 47, wherein the selective activation is achieved by blocking selective regions by mask materials.

49. The method of claim 48, wherein the mask materials are metals, plastics, rubbers, or paper tapes.

50. The method of claim 47, wherein the selective activation is achieved by using specially designed electrodes with a shape identical to the pattern of discrete regions.

51. The method of claim 44, wherein the high energy activation is electron beam activation.

52. The method of claim 51, wherein the selective activation is achieved by focusing the electron beam to specified areas.

53. The method of claim 33, 37 or 43, wherein the method further comprises coating the discrete surface regions with coating materials for a time and at a temperature sufficient for a formation of a layer covering the discrete regions.

54. The method of claim 53, wherein the coating material is polyelectrolyte, neutral polymer, small molecule, biomolecule, or combination thereof.

55. The method of claim 54, wherein the polyelectrolytes are phosphates, polyethyleneimides, poly(vinylimidazoline), quaterized polyacrylamides, carboxyl modified polyacrylamides, polyvinylpyridines, poly(vinylpyrrolidone), polyvinylamines, polyallylamines, chitosans, polylysines, poly(acrylate trialkyl ammonia salt ester), cellulose, poly(acrylic acid), polymethylacrylic acid, poly(maleic acid), poly(styrenesulfuric acid), poly(vinylsulfonic acid), poly(toluene sulfuric acid), poly(methyl vinyl ether-alt-maleic acid), poly(glutamic acid), surfactants, Nafion® (DuPont), dextran sulfates, hyaluric acid, heparin, alginic acid, adipic acid, chemical dyes, proteins, enzymes, nucleic acids, peptides, and salts, esters, and/or copolymers thereof.

56. The method of claim 54, wherein the small molecule is sodium dodecylsulfonate, dodecyltrimethylamonium bromide, phosphate, sulfonate, bronate, sulfonate, dye, lipid, metal ion, or surfactant containing fluorine.

57. The method of claim 54, wherein the biomolecule is a protein, an enzyme, a lipid, a hormone, a peptide, a nucleic acid, an oligonucleic acid, a DNA, an RNA, a sugar, or a polysaccharide.

58. The method of claim 53, wherein the layer is bound to the discrete region by covalent bonds, electrostatic interactions, or combination thereof.

59. The method of claim 53, wherein the method further comprises coating the single layer-coated discrete regions with additional coating materials for a time and at a temperature sufficient to form a second layer on the discrete regions.

60. The method of claim 59, wherein the second layer is bound to the first layer by covalent bonds, electrostatic interactions, or combination thereof.

61. The method of claim 59, wherein the coating can be repeated to form a multilayer coated porous material.

62. A method of claim 53, wherein the method comprises: providing a substrate with charged discrete regions; reacting the charged discrete regions with an opposite charged molecule containing a functional group.

63. The method of claim 62, wherein the charged molecule contains polyethylene glycol.

64. The method of claim 62, wherein the charged molecule contains biotin.
